(19) United States
(12) Patent Application Publication
(10) Pub. No.: US 2010/0055251 A1
(43) Pub. Date: Mar. 4, 2010

(54) FAT SOLUBLE FOOD BAR

(75) Inventor: ANSELM IGBANUGO, TOMS RIVER, NJ (US)

Correspondence Address: FONDUNGALLAH KIGHAM & ESSIEN, LLC, 2499 RICE STREET, SUITE 236, SAINT PAUL, MN, 55113, US

(73) Assignee: PREVENTIVE HEALTHCARE, LLC, TOMS RIVER, NJ (US)

(21) Appl. No.: 12/198,299

(22) Filed: Aug. 26, 2008

(51) Int. Cl. A23L 1/303; A23L 1/302

(52) U.S. Cl. 426/73; 426/72

(57) ABSTRACT

The present invention provides a food bar having a core section that is laden with calcium and fat soluble vitamins. Preferably the core section comprises chocolate and may include crisp rice cereal, marshmallow or other material. The fat soluble vitamins provided in the present invention are vitamins A, D, E and K. The present invention may include vitamin C.

### BACKGROUND

Food bars abound in the marketplace, usable as snacks, supplements or substitutes for meals. Food bars are commonly provided in the form of nuggets, bars, rounds, cylindrical or in suitable wafers, depending on use or composition. Generally, food bars are made available as edible components and preferable with the convenience for consumption in less formal settings, such as when one is on-the-go or in-between meals.

In an ever increasingly busy world, consumers are increasingly finding it convenient to ‘snack-on’ a food bar while continuing their activities. It is also becoming increasingly common for some consumers to use the food bar as a means of meeting their needed caloric intake without the challenge or disadvantage of regulating the nutrients that they consume. As a consequence or in part due to these new lifestyles, some consumers are consuming more of one type of food, such as chocolate and less of other nutrients that support healthy living. As an example, some consumers have a preference for chocolate confectionaries, but are concerned that their use of the product may not provide enough of the needed nutritional benefits outside of the caloric intake. The present invention provides an avenue to include useful nutrients in a food bar.

In some instances, additives added to the formulation of food bars include vitamins or precursors that are useful for one nutritional purpose or another. In a similar manner, manufacturers of food bars have incorporated other medicinal aspects into their product. Another aspect of the use of food bars is its use in the supplement industry as nutraceuticals and as a vehicle to deliver a variety of supplements.

Chocolate and chocolate based food bars are known for the appeal. Chocolate lovers are sometimes concerned about the effects of consuming chocolate on a regular basis because of the caloric or other unintended consequences. The combination of calcium with chocolate in a food bar is not readily available and known combinations with selected vitamins are even rarer or non-existent. A value in the use and consumption of chocolate based food bars can be noted with the provision of some beneficial component, such as calcium and vitamins.

The incorporation of fat soluble vitamins in food bars has been a challenge when and where the goal is provision in a desired or appropriate combination.

From the foregoing, it will be appreciated that what is needed in the art is an edible article that can provide the combination of calcium and fat soluble vitamins in the convenience of a food bar. Such a food bar is disclosed and claimed herein.

### SUMMARY

In one embodiment the present invention provides a food bar having a core material and fortified with calcium and fat-soluble multivitamins. The core material of the present invention may preferably include chocolate. In some embodiments, the core material may include crisp rice cereal, marshmallow or other suitable edible material. The food bar of the present invention is preferably fortified with calcium and a select fat soluble vitamins, preferably vitamins A, D, E and K.

In an embodiment of the present invention, the food bar includes at least about 1,200 mg of Calcium, about 3750 IU of vitamin A, about 400 IU of vitamin D, about 30 IU of vitamin E, and about 25 mcg. of vitamin K.

The present invention may include about 600 mg of vitamin C as an added supplement.

The present invention provides the fat soluble vitamins in an amount suitable to meet or exceed the Recommended Daily Allowance for such vitamins in combination with chocolate and in a chocolate food bar.

### DETAILED DESCRIPTION

In an embodiment of the present invention, a food bar is provided preferably having a core or textured middle section and a coating. The core section of the food bar of the present invention preferably includes chocolate, a desirable amount of calcium and fortified with a combination of fat soluble vitamins supplements. The present invention further preferably provides a food bar that has a rich mouth-feel. As described herein, mouth-feel refers to the sensory evaluation of the food bar in the palette of the consumer or how the food bar feels in one's mouth. Mouth-feel may be described as rich, creamy, dry or poor.

The food bar of the present invention is preferably provided under the same process as is known in the art. Exemplary processes for the manufacture of food bars are disclosed in U.S. Pat. No. 6,953,588B2, titled “Multi-Vitamin and Mineral Supplement,” and issued to Kenneth H. Cooper, et al. Other methods of manufacture of food bars are known and incorporated in the instant invention.

The present invention preferably discloses a food bar having a core section that may comprise a textured core substrate made of chocolate, caramel, nuts, crispy rice, marshmallow coconut, or other suitable edible material as is used in the production of food bars. As is commonplace, the food bar of the present invention may include an inner layer that is coated with an edible adhesive binder to hold together the inside of the food bar, especially where the components are flaky or loose.

The present invention provides a core substrate for the food bar that is usable as a carrier or base for other nutrients that may appropriately be incorporated in the textured substrate. Such incorporation may include vitamins or additives or medically useful adjuvants. It is reasonable to incorporate adjuvants or additives that provide medicinal or nutritional aid to the consumer. As an example, the food bar of the present invention may be provided with supplements to boost one or more desired results, such as, energy replenishment, cold fighting, for active consumers, and the like.

The present invention preferably provides calcium in combination with fat soluble vitamins. Calcium is noted for its usefulness in bone maintenance and recommended amounts, as Recommended Daily Allowance (RDA) have been established for calcium intake. These RDA depend to some extent on the consumer and reasons for needing more calcium in the diet. The primary source for calcium is milk and consumers are usually advised to consume some amount of milk each day for the attendant benefit of boosting their calcium intake. However, some people are lactose intolerant and cannot drink milk or similar dairy products. Thus, by this product there is presented another option for a consumer who, for one reason or another cannot consume other calcium enriched products, such as milk to obtain his or her RDA without the concerns attributable to those sources.

Depending on age and other factors that may call for the use of supplements, the various RDA for calcium are documented in everyday literature and vitamin sources. As an example, a daily intake of about 1,000 mg of calcium is the Recommended Daily Allowance (RDA) for most 19-50 year-olds' general health, especially bone health. For older adults (over 50 yrs) and people with osteoporosis, the RDA is about 1,200 up to 1,800 mg of calcium, depending upon bone health. The required RDA of calcium in adolescent children (9-18 yrs) and lactating and pregnant women is about 1,300 mg daily. The food bar of the present invention preferably provides between about 800 and 2,000 milligrams, more preferably between about 900 and 2,000, most preferably between about 1,200 and 1,800 milligrams per serving of calcium.

As is known in the art, the combination of calcium and other fat soluble vitamins may provide a poor mouth-feel to the food bar due to the chalkiness of the calcium. The present invention provides calcium and fat soluble vitamins in a ratio without negatively impacting mouth-feel. It is preferable that the mouth-feel of the present invention be creamy and rich.

The food bar of the present invention is preferably comprises a select fat soluble vitamins that provide useful nutrients but may not be lost as the body limits its intake on a particular dosage as with water soluble vitamins. The instant invention preferably provides fat soluble vitamins in amounts suitable to meet both the RDA and to provide a reliable source for the each offered vitamin. The select combination of fat soluble vitamins provided in the present invention are preferably vitamins A, D, E, and K.

Fat soluble vitamins refer to vitamins A, D, E and K that require fat for absorption in the body and are may be stored in the fat cells of the body called lipocytes, unlike water soluble vitamins that are typically not retained in the body except in small quantities. Fat soluble vitamins provide benefits to the consumer and remain in the body until the body needs them. In this process, fat soluble vitamins need not be replaced often as there is potential for oversupplementation. In this disclosure, “oversupplementation” implies the accumulation in the body of supplements or vitamins which would otherwise have been excreted but for storage in the lipocytes of the body. The present invention is directed to a food bar such that when consumed on a daily basis provides a desirable amount of fat soluble vitamins with minimal risk of oversupplementation.

The present invention provides vitamin A (retinol) in an amount suitable to satisfy the RDA without oversupplementation. Literature notes vitamin A as useful in eyesight, especially at night; bone growth, tooth development, reproduction, cell division and gene expression. Other references have noted its use in promoting growth in kids and healthy skin maintenance in adults. The benefits of vitamin A for daily and improved living are thus noted. The RDA for vitamin A is between about 300 and 1300 milligrams per day. The present invention provides preferably between about 100 and 1800 milligrams, more preferably between about 200 and 1700 milligrams and most preferably between about 300 and 1700 milligrams of vitamin A per serving. In International Units, the preferred amount is about 3750 IU per serving.

Another fat soluble vitamin provided by this invention is vitamin D. Vitamin D is essential for promoting calcium absorption in the gut and maintaining adequate serum calcium and phosphate concentrations to enable normal mineralization of bone and prevent hypocalcemic tetany. Vitamin D deficiency is linked with a multitude of clinical manifestations (osteopenia, osteoporosis, chronic pain syndromes and fibromyalgia) which can affect all activities of daily living. Vitamin D has other roles in human health, including modulation of neuromuscular and immune function and reduction of inflammation. Without sufficient vitamin D, bones can become thin, brittle, or misshapen. Vitamin D sufficiency prevents rickets in children and osteomalacia in adults. Together with calcium, vitamin D also helps protect older adults from osteoporosis. The present invention provides an adequate supplementation of vitamin D, sufficient to meet the RDA of between about 200 and 600 IU per day. Preferably, the present invention provides between about 200 and 700 IU, more preferably between about 200 and 650 IU, and most preferably between about 200 and 600 IU of vitamin D per serving of the food bar.

The present invention also provides vitamin E. Although there are many forms of vitamin E, the more usable and preferred form is alpha-tocopherol (α-tocopherol), which is the name of the most active form of vitamin E in humans. It is also a powerful biological antioxidant. Vitamin E in supplements is usually sold as alpha-tocopheryl acetate, a form of alpha-tocopherol that protects its ability to function as an antioxidant. Antioxidants such as vitamin E act to protect your cells against the effects of free radicals, which are potentially damaging by-products of energy metabolism. Free radicals can damage cells and may contribute to the development of cardiovascular disease and cancer. Some commentators have indicated that vitamin E, through its ability to limit production of free radicals, might help prevent or delay the development of those chronic diseases. Vitamin E has also been shown to play a role in immune function, in DNA repair, and other metabolic processes. The RDA for vitamin E ranges between 9 and 30 IU. The present invention provides between about 5 and 30 IU of vitamin E, preferably more than 5 IU per serving.

Another fat soluble vitamin provided by the present invention is vitamin K. Vitamin K is a fat-soluble vitamin that plays an important role in blood clotting and in some measure with proteins for bone maintenance. Without vitamin K in the body, blood would not clot. The body can store fat-soluble vitamins in fatty tissue. Some studies indicate that it helps in maintaining strong bones in the elderly.

Overt vitamin K deficiency results in impaired blood clotting. Symptoms include easy bruising and bleeding that may be manifested as nosebleeds, bleeding gums, blood in the urine, blood in the stool, tarry black stools, or extremely heavy menstrual bleeding. In infants, vitamin K deficiency may result in life-threatening bleeding within the skull (intracranial hemorrhage). The RDA for vitamin K is between 20 and 120 micrograms per day. Most adults should consume between about 70 and 80 mcg of vitamin K per day. The present invention preferably provides about 25 mcg per serving of vitamin K, sufficient to provide required nutrients and at an approximate value for safe use with blood thinning medication.

The food bar of the present invention may optionally include vitamin C (Ascorbic acid.) Out of the many noted benefits of vitamin C, including the prevention of scurvy—seepage of blood from capillaries, subcutaneous bleeding, weakness of muscles, soft, spongy gums and loss of dental cement leading to loss of teeth, and, in advanced cases, deep bone pain. Vitamin C is also to aid in the healing of wounds, endothelial repair, and absorption of elemental iron. It is also needed for bone growth and bone remodeling by osteoblasts and osteoclasts. An adequate supply of vitamin C in the body has been noted to help the prevention of common colds. The amount of vitamin C that may be included in the present invention is preferably between about 200 mg and 3000 mg, more preferably between about 350 mg and 2500 mg, and most preferably between about 550 mg and 2000 mg. It is notable that there is no evidence of adverse effects at intakes up to 4000 mg/day as most excess vitamin C is excreted by urination.

In addition to the above nutritional components, the food bar may contain other food product ingredients such as emulsifiers, flavorants, high intensity sweeteners and the like. Emulsifiers may be added for stability of the product. Emulsifiers include lecithin, polyglycerol esters, sorbitan, fatty acid esters, mono- and di-glycerides, and the like. Lecithin is a preferred emulsifier.

It is an object of the present invention to provide not simply a nutritious food bar but to provide a superior tasting nutritious food bar that is also light on calories. The present invention also provides for a good tasting food bar, with a pleasant mouth-feel, one having the appealing taste of a chocolate candy bar and/or in some cases, confectionery coated sweet that may include a crisp and crunchy core. The food bar of the present invention may include a core section comprising crispy rice. When the core section includes crispy rice, one of the keys to the superior taste character, mouth-feel and organoleptic acceptability of the food bar is the use of a particular combination of ingredients which generally fall into the category of the above discussed cereal grains.

The cereal grain incorporation process involves mixing kernels with a flavor solution (e.g. sugar, malt syrup, salt, water) and optional vitamin mixes, then cooking, drying, cooling and tempering, and toasting the crisp. Toasted puffed rice crisp are readily available from local food manufacturers such as Kellogg N.A., among others. Extruded rice crisp are typically made from rice flour or milled rice, with whole kernels or parts of kernels also optionally used. Extruded rice crisp are available from Pacific Grain and Foods, California, among others. These two rice crisps components are suitably used in ratios of from about 80:20 to about 40:60 with ratios of about 70:30 to about 50:50 preferred, in amounts of from about 10-30% by weight of the food bar with amounts of about 15-25% preferred. These components contribute to the carbohydrate, including fiber, content of the food bar.

Marshmallow mixes that may be used in this invention are the normal marshmallow mixes well known in the industry. Ingredients used in marshmallow production as well as amounts thereof are well known in the marshmallow industry. Among the many formulas that are acceptable for marshmallow production are those found in the following: Candy Making As a Science and Art, by Claude D. Barnette, Don Guessel Publications, Inc., New York, 1960, pp. 99-103 and Encyclopedia of Candy and Ice Cream Making, by Simon I. Leon, Chemical Publishing Co., New York, 1959, pp. 294-304; and A Textbook on Candy Making, by Alfred E. Leighton, Manufacturing Confectioners Publishing Co., Oak Park, Ill. 1952 pp. 55-68, as adapted to suit the intended purpose of producing a principally chocolate based food bar having calcium and fat soluble vitamins.

The chocolate core of the food bar is preferably enrobed in a confectioner's coating which is a compound coating or another chocolate coating. The use of a confectioner's coating on the core adds to the sweet, candy bar-like appeal of the food bar. Compound coatings may be unflavored or flavored with chocolate, vanilla, peanut, coconut, yogurt, fruit flavors and the like. The amount of coating applied to the core typically constitutes about 10 to 40% by weight of the weight of the bar wherein the core constitutes the remaining 90 to 60% by weight. Chocolate coatings may include cocoa butter and may be white or dark or milk chocolate. As consumers are becoming more and more conscious of their caloric intake, a preferred chocolate core and food bar of the present invention may be low in fat and caloric content.

Flavorants may be used in both the coating and the core of the bar. Flavorants are used in the form of synthetic flavor oils and flavoring aromatics, and/or oils, oleo resins and extracts derived from plants, leaves, flowers, fruits and so forth, and combinations thereof. Non-limiting representative flavor agents include flavor oils such as spearmint, cinnamon, oil of wintergreen (methyl salicylate), peppermint (menthol), clove, bay, anise, eucalyptus, thyme, cedar leaf, oil of nutmeg, allspice, oil of sage, mace, oil of bitter almonds, and cassia oil; artificial, natural and synthetic fruit flavors such as vanilla; citrus oils including lemon, orange, lime, grapefruit; and fruit essences including apple, pear, peach, banana, grape, strawberry, raspberry, cherry, plum, pineapple, apricot and so forth; chocolate flavorings, peanut butter flavoring, rum, butterscotch, toffee, cocoa, coconut, carob, honey, pecan, pistachio, almond, butter, yogurt, and the like. Generally any flavoring or food additive such as those described in Chemicals Used in Food Processing, publication 1274, pages 63-258, by the National Academy of Sciences, may be used.

The food bar of the present invention may include high intensity sweeteners such as saccharin, cyclamates, aspartame, acesulfame-K, and the like; and humectants such as glycerin, sorbitol, xylitol, fructose, dextrose, propylene glycol and other polyols. Other common ingredients such as colorants, preservatives/antioxidants, may be added. The amount of ingredients incidental to the sustained energy/nutrition objects of the food bar may vary depending on the formulation, end use and consumer preferences.

The food bar may be manufactured by methods commonly used for non-baked food bars. This process comprises mixing dry ingredients, separately preparing the binder blend (syrup slurry), adding the binder to the dry blend with mixing, heating as necessary to blend the materials, then adding sensitive materials such as flavorants. The bar cores may be formed by conventional methods including extrusion and sheet forming methods. In extrusion, the ingredients are transferred to a conventional confectionery bar extruder having roller bars which force the mixture through a die to form the core which can be cut into appropriate size. In a sheet method, the mixed ingredients are formed into sheets through roller presses, cut into ribbons subsequently cut into the appropriate size bar core. Any topping layers are applied to the core prior to coating. The bar core is preferably then cooled, and if necessary, coated (enrobed) with a chocolate or compound coating.

Having thus described the preferred embodiments of the present invention, those of skill in the art will readily appreciate that the teachings found herein may be applied to yet other embodiments within the scope of the claims hereto attached. The complete disclosure of all patents, patent documents, and publications are incorporated herein by reference as if individually incorporated.

What is claimed is:

1. A food bar, comprising:
a core section and a confectioner coating; said core section comprising,
chocolate;
at least 1000 milligrams of calcium per serving;
fat soluble vitamins incorporated in the core section, wherein said combinations of calcium and fat soluble vitamins with chocolate provide suitable mouth-feel; and
a confectioner coating comprising,
chocolate, caramel, nuts or combinations thereof.

2. The food bar of claim 1, wherein the core section includes fillers selected from a group consisting of crispy rice, extruded rice, marshmallow, peanut butter, coconut, almonds, nuts or combinations thereof.

3. The food bar of claim 1, wherein the core section is formed with caramel.

4. The food bar of claim 1, wherein the core section includes wafers.

5. The food bar of claim 1, wherein the chocolate is selected from a group consisting of white, dark, or combinations thereof.

6. The food bar of claim 1, wherein the core section comprises at least about 1200 mg of c calcium per serving.

7. The food bar of claim 1, wherein the fat-soluble vitamins comprises Vitamins A, D, E and K.

8. The food bar of claim 4, wherein the fat-soluble vitamin include at least about 3750 International Units of Vitamin A per serving.

9. The food bar of claim 4, wherein the fat-soluble vitamin include at least about 400 International Units of Vitamin D per serving.

10. The food bar of claim 4, wherein the fat-soluble vitamin include at least 30 International Units of Vitamin E per serving.

11. The food bar of claim 4, wherein the fat-soluble vitamin include at least about 25 mcg of Vitamin K per serving.

12. The food bar of claim 1, wherein the confectioner coating comprises a blend of chocolate and almond.

13. The food bar of claim 1, wherein the core section presents between about 60 and 80 percent by weight of said bar and a coating of between about 20 and 40 percent by weight.
